(19) United States
(12) Patent Application Publication
(10) Pub. No.: US 2022/0161254 A1
(43) Pub. Date: May 26, 2022

(54) ARTICLES, SYSTEMS, AND METHODS FOR LIQUID TRANSFER AND AUTOMATED INNOCULATION

(71) Applicant: 3M INNOVATIVE PROPERTIES COMPANY, St. Paul, MN (US)

(72) Inventor: Gregory W. Sitton, Minneapolis, MN (US)

(21) Appl. No.: 17/617,073

(22) PCT Filed: Jun. 23, 2020
(86) PCT No.: PCT/IB2020/055936

§ 371 Date: Dec. 7, 2021

Related U.S. Application Data
(60) Provisional application No. 62/867,413, filed on Jun. 27, 2019.

(51) Int. Cl. B01L 3/00; B01L 9/00

(52) U.S. Cl. CPC B01L 3/50857; B01L 9/523; B01L 2300/0829; B01L 2300/043; B01L 2300/044; B01L 2200/025

(57) ABSTRACT

Articles, systems, and methods for transferring liquids that may employ a robot.

### BACKGROUND

Many industrial procedures, for example inoculation, require transfer of liquids from one vessel to another vessel.

### DETAILED DESCRIPTION

Throughout this disclosure, singular forms such as “a,” “an,” and “the” are often used for convenience; however, the singular forms are meant to include the plural unless the singular alone is explicitly specified or is clearly indicated by the context. When the singular alone is called for, the tern “one and only one” is typically used.

Some terms in this disclosure are defined below. Other terms will be familiar to the person of skill in the art, and should be afforded the meaning that a person of ordinary skill in the art would have ascribed to them.

The terms “common,” “typical,” and “usual,” as well as “commonly,” “typically,” and “usually” are used herein to refer to features that are often employed in the invention and, unless specifically used with reference to the prior art, are not intended to mean that the features are present in the prior art, much less that those features are common, usual, or typical in the prior art.

The term “PCR” is an acronym for polymerase chain reaction, a method of amplifying DNA or RNA that is well known to the artisan. PCR is commonly performed in a vessel having a standard size and shape that is known to the artisan and is referred to in this disclosure as a “PCR tube.”

An “Eppendorf tube” is a type of vessel having a particular size and shape and used in, for example, the microbiology arts and is known to practitioners of those arts.

Transferring liquids from one location to another is an important part of many industrial processes, such as inoculation processes. In some such processes, it is necessary to keep a vessel that a liquid will be transferred into or out of covered until a liquid is added or removed from the container.

This is a significant challenge when the liquid transfer is being performed in an automated fashion by a robot. It is very difficult for a robot to accurately and consistently carry out a capping or de-capping step. This is true because a human can adjust for slight displacement of a vessel's cap from its expected location or orientation whereas a robot is not capable of making such adjustments. Thus, even small variations in the location of a cap can render it impossible for a robot to successfully locate and manipulate a cap to place the cap on remove it from a vessel. This is particularly true when the vessel and cap are small, such as a PCR tube, Eppendorf tube, or test tube.

Briefly, a solution lies a method wherein one or more vessels, which are typically already in an uncovered or decapped configuration, are covered with a pipette-tip pierceable film before being loaded onto the deck of a robot. The robot is able to be equipped with a pipette tip. Once the one or more vessels are loaded and the robot is equipped with a pipette tip, the robot pierces, by the pipette tip, the pipette-tip pierceable film and dispenses liquid into at least one of the vessels or removes liquid from at least one of the vessels.

The one or more vessels are typically decapped by a human. This most often takes place before the vessels are loaded onto the deck of the robot, but it can take place after they are loaded in some cases. Likewise, the step of covering the one or more vessels with the pipette-tip pierceable film most often takes place before the one or more vessels are loaded onto the deck of the robot, but it can take place after they are loaded in some cases so long as the vessels are in a decapped or uncovered state when they are covered by the pipette-tip pierceable

One or more liquids can be added to the one or more vessels. Additionally, or in the alternative, one or more liquids can be removed from the one or more vessels. In some cases, it can be useful to both remove and add one or more liquids from the one or more vessels. For example, a liquid can be added to the one or more vessels and then the contents of the one or more vessels can be mixed by removing liquid from the one or more vessels and then ejecting the liquid back into the vessel from which it was removed.

The one or more vessels may be empty when they are loaded onto the deck of the robot, but more often they will contain at least one solid or at least one liquid at the time they are loaded onto the deck of the robot and at the time they are covered with the pipette-tip pierceable film.

The pipette tip-pierceable film that typically has moisture barrier properties, oxygen barrier properties, or both, and may also be partially or completely opaque to particular wavelengths of electromagnetic radiation, typically visible or UV light. Use of the method as described herein with the pipette tip-pierceable film allows the plurality of vessels to remain covered while awaiting the addition of liquid to a plurality of vessels by a robot without the need for a human or robot to de-cap the vessels before the robot adds liquid to the vessels. Materials suitable for use as pipette tip-pierceable film include those films with moisture or oxygen barrier properties that can be readily pierced by a pipette tip. Examples include aluminum films, such as aluminum foils or multilayer films having one or more aluminum layers and one or more layers of other materials, polypropylene films, optically clear polyester films, films obtainable from Applied Biosystems as part number 4311971, films obtainable from Thermo Scientific under the trade designation AB0558, films obtainable from Grenier under the trade designation Bio-One AMPLIseal RT-PCR Adhesive Sealer, and films obtainable from Corning as part number 6570.

The method is often employed with the use of a specially designed transfer tray. The transfer tray allows for specific placement of a plurality of vessels in space so that they can be placed in known locations on a deck of the robot. It also allows for a plurality of vessels to be transferred to or front the deck of the robot at the same time, thereby reducing human error and saving time.

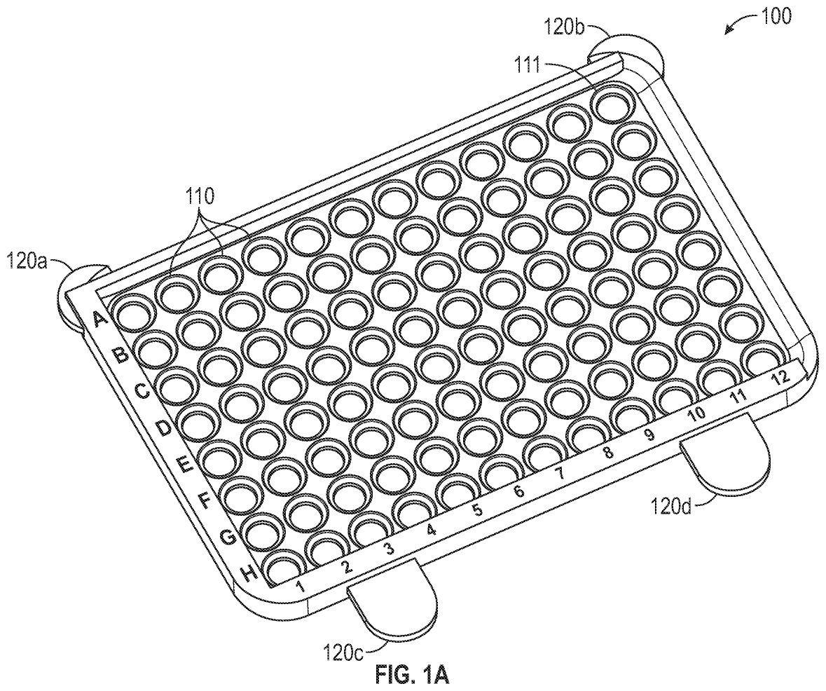

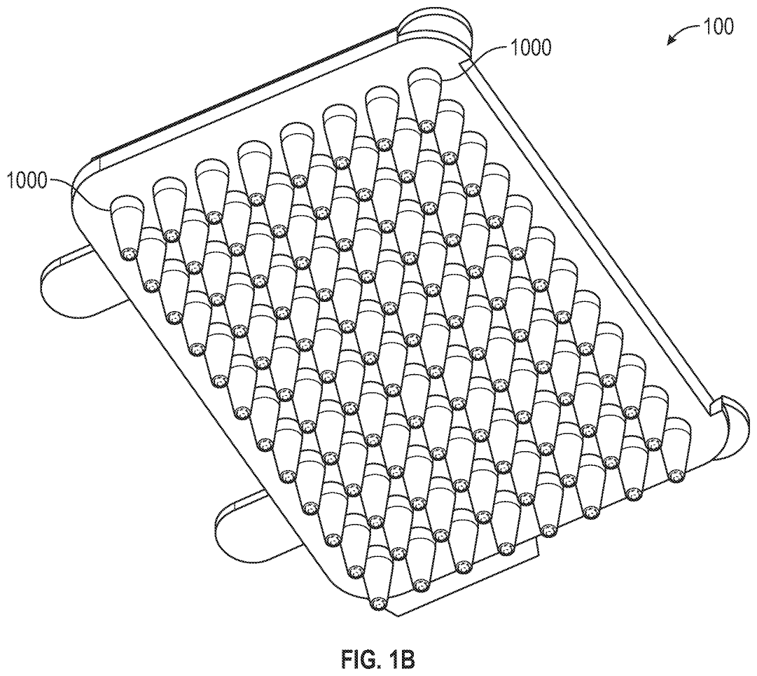

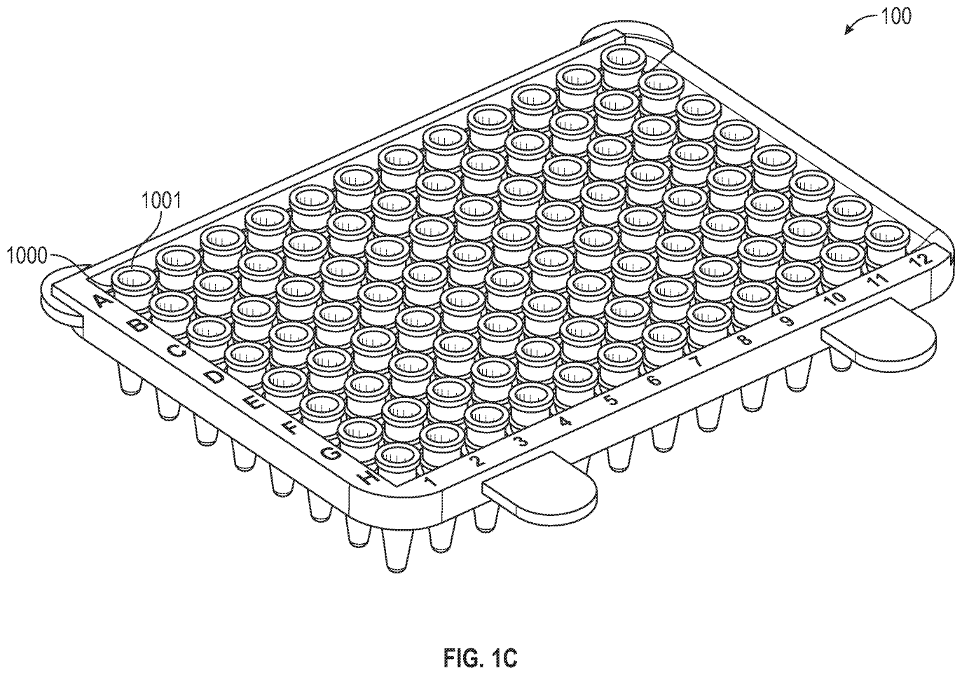

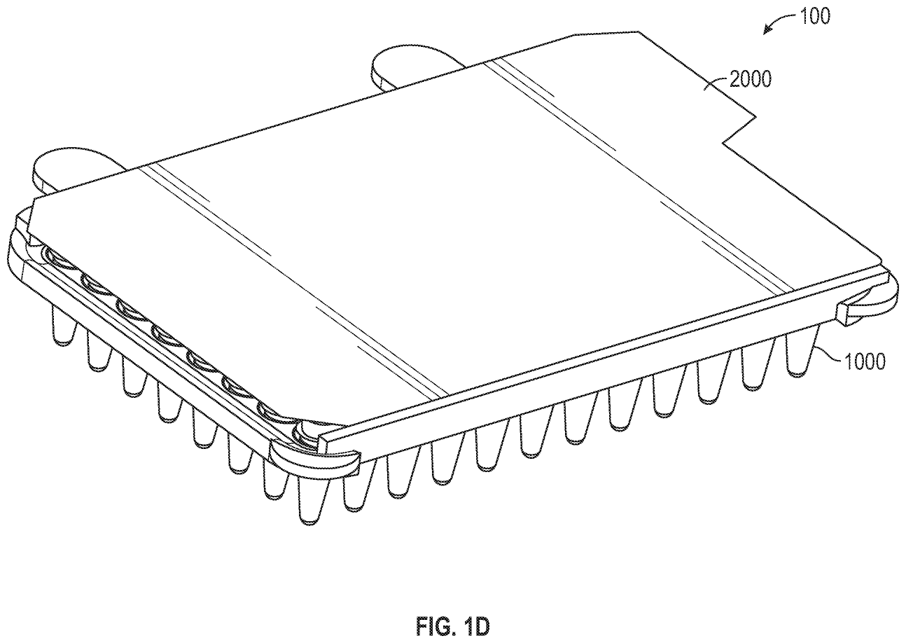

The transfer tray has two components, which are not integrally formed. FIG. 1A depicts one of these components, vessel holder 100 having a plurality of openings 101 for receiving vessels. In this Figure, the openings 110 have bevels 111 for retaining vessels. Bevels 111 are not present in all cases; whether they are present, and if present their specific geometry, will depend on the shape of the vessels that will be used with vessel holder 100. When PCR tubes or Eppendorf tubes are used as vessels, bevels 111 are commonly employed and shaped to steady those vessels in vessel holder 100. In FIG. 1, there are 96 holes 110 arranged in an 8×12 grid. This configuration is common because it is familiar to practitioners of the microbiological arts; however other configurations can also be used depending on the needs of the practitioner.

Vessel holder 100 is also configured with tabs 120a, 120b, 120c, and 120d. These tabs are asymmetric tabs in that they are able to engage with tray 200 (not shown in FIG. 1) in only one way so as to prevent improper loading of vessel holder 100.

FIG. 1B depicts vessel holder 100 with a plurality of vessels 1000 loaded into openings 110. In this Figure the plurality of vessels 1000 are PCR tubes, but it should be noted that other vessels could also be employed.

FIG. 1C depicts another view of vessel holder 100 with a plurality of vessels 1000 loaded into openings 110. In this Figure, each vessels 1000 is covered with cap 1001.

FIG. 1D depicts vessel holder 100 with a plurality of vessels 1000 loaded into openings 110. In this Figure, the caps 1001 (not shown) have been removed from vessels 1000, which are instead covered by pipette tip-pierceable film 2000. Pipette tip-pierceable film. 2000 is configured to adhere or otherwise remain on the top of vessels 1000. Pipette tip-pierceable film 2000 typically has moisture barrier properties, oxygen barrier properties, or both, and may be at least partially opaque to at least one wavelength of electromagnetic radiation, typically visible light or UV light. Materials suitable for use as pipette tip-pierceable film 2000 include those discussed herein.

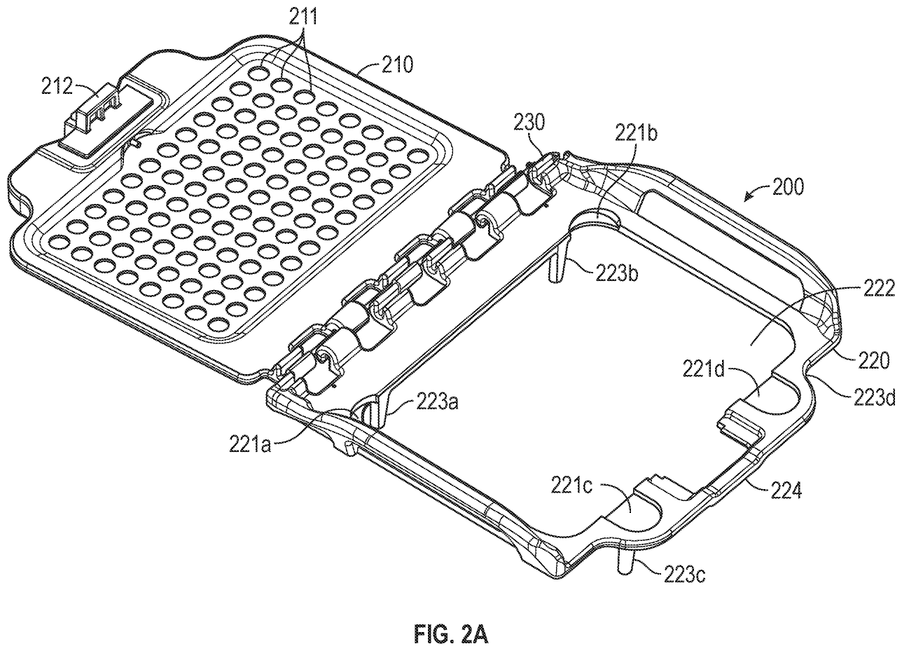

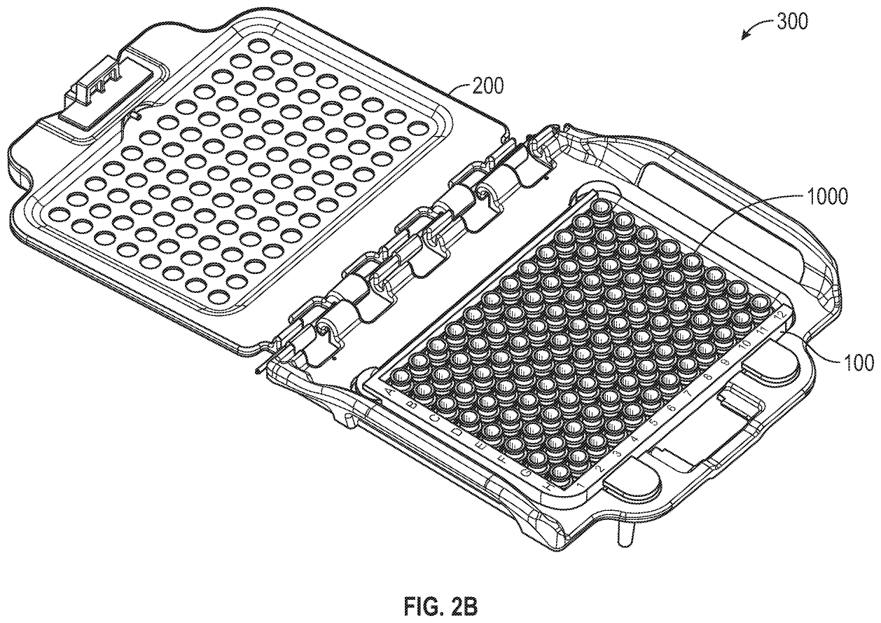

FIG. 2A depicts the other component of the transfer tray, stand 200, in an open configuration. In this configuration, top portion 210 is connected to bottom portion 220 by way of hinge 230. Bottom portion 220 is configured to receive vessel holder 100, and incudes recesses 221a, 221b, 221c, and 221d configured to receive tabs 120a, 120b, 120c, and 120d. Tabs 120a, 120b, 120c, and 120d and recesses 221a, 221b, 221c, and 221d are oriented asymmetrically such that there is only one possible way to fit vessel holder 100 (not shown in this Figure) into stand 200. Bottom portion 220 also includes a void 222 which receives vessels 1000 (not shown in this Figure) when vessels 1000 are loaded in vessel holder 100. Legs 223a, 223b, 223c, 223d elevate stand 200 so that when vessel holder 100 is loaded with vessels 1000 and received in stand 200, the vessels 1000 will not be disturbed by a surface on which stand 200 rests. Top portion 210 includes a plurality of openings 211 which align with openings 111 in vessel holder 100. Thus, while the Figures show a particular configuration of openings 211, other configurations are possible depending on the configuration of openings 111 in vessel holder 100. Latch 212 is located on top portion 210 so that it can engage with latch receiver 224 on bottom portion 220 when stand 200 is closed.

FIG. 2B depicts transfer tray 300 having stand 200 in its open configuration and vessel holder 100 resting in stand 200. Vessels 1000 are loaded into vessel holder 100.

In use, a first substance is typically provided in one or more vessels 1000. Provided can mean that the substance has been pre-loaded within the one or more vessels 1000 or it can mean that it is placed within the one or more vessels 1000, among other things. The substance can be a solid or liquid, or a mixture of the two (such as a dispersion or colloid), and can even include one or more gases dispersed or dissolved in the solid, liquid, or mixture. Caps 1001 are removed from vessels 1000, typically by a person and most often by use of a cap-removal tool such as those disclosed in U.S. Pat. No. 9,079,757. Pipette-tip pierceable film 2000 is then placed over the top of one or more vessels 1000 to cover vessels 1000. Stand 300 is then positioned in a closed position by moving top portion 210 to engage with or rest atop bottom portion 220, such as by engaging latch 212 with latch receiver 224.

Once one or more vessels 1000 are covered, as shown in detail in FIG. 1D, the content of one or more vessels 1000 is protected from air, moisture, and the like at least as well as it would have been if one or more caps 1001 remained on top of the one or more vessels 1000. Thus, one or more transfer trays 300 can be loaded with one or more vessels 1000 and stored for future use, for example, for inoculation of the one or more vessels 1000 by a robot, just as if the one or more vessels 1000 were capped.

Transfer tray 300, which at this point includes one or more vessels 1000 can then be moved onto a deck of a robot, which is a working location on, in, or engaged with the robot. The robot will typically be equipped to carry out one or more liquid transfer protocols. Suitable robots are commercially available or have been described, for example those available from Hamilton Company under the trade designations NIMBUS, STAR, STARlet, or VANTAGE, from Tecan under the trade designation FLUENT, from Beckman Coulter under the trade designation BIOMEK, and those described in U.S. Pat. Nos. 5,324,480, 5,531,959, and 8,028,843.

It should be noted that the precise shape of transfer tray 300, including the vessel holder 100 and stand 200 may vary somewhat from what is depicted in the Figures in order to meet the requirements of the particular robot being employed. Transfer tray 300 can be moved onto the deck of the robot in any suitable way, such as by a human operator, by the robot, or by a mechanical loading device.

Once loaded onto the deck of the robot, the location of the openings of the one or more vessels 1000 will be known to the robot so that a liquid transfer protocol can be accomplished. This is true even though the one or more vessels 1000 are covered by pipette tip-pierceable film 2000.

The robot can then use a pipette tip to pierce the pipette tip-pierceable film 2000 and deliver liquid to or remove liquid from one or more of the one or more vessels 1000. The void 223b in stand 200 ensures that a small amount of movement or play in the one or more vessels 1000 is possible. This increases the tolerance of the location of a pipette tip so that it can succeed in delivering liquid to one or more of the one or more vessels 1000 while keeping stand 200 closed ensures that vessels 1000 do not tip over or become dislodged from transfer tray 300. In addition to delivering or removing liquid, the robot can perform other operations such as agitating or mixing the one or more vessels 1000.

Liquid can be added to or removed from one or more vessels 1000 by way of one or more pipette tips that are employed by a robot for this purpose. A pipette tip can pierce the pipette tip-pierceable film in order to accomplish this. The pipette tip can then be used to add liquid that is contained, for example, in a reservoir in another part of the robot, or remove liquid for delivery to another location. One or more different types of liquid can be added to each of the one or more vessels in one or more separate steps. The pipette tip can also mix the content of any of the one or more vessels 1000, for example by taking up liquid from the one or more vessels 1000 and then ejecting the liquid back into the same vessel 1000 to create liquid turbulence that mixes the contents of the vessel 1000.

It is also possible for a robot to have other modules, such as an agitator module or heating module, for performing other steps on transfer tray 300 and one or more vessels 1000.

After the liquid transfer steps, including any other steps to be performed by the robot, are complete, the transfer tray 300 can be unloaded from the robot. This can be performed by any of the ways mentioned herein with regard to loading the transfer tray 300 onto the robot.

The robot can change pipette tips at any time that such a change may he necessary or desired. For example, the robot can change pipette tips after delivery of liquid to one the one or more vessels 1000 and before delivering liquid to the next one or more vessels 1000.

In particular cases, the delivery of liquid to the one or more vessels can comprise inoculating the one or more vessels 1000.

The one or more vessels 1000 may be empty when they are loaded onto the transfer tray, or they may contain a liquid or solid substance. Exemplary liquid or solid substances include substances that are useful for the detection of microorganisms, for example, substances that promote lysis of microorganism cell walls or amplification of microorganism DNA or RNA. Exemplary vessels 1000 that can be used are vessels sold as part of the Molecular Detection Assay by 3M Company (St. Paul, Minn., USA) which come pre-loaded with solids that facilitate detection of microorganisms in a sample.

Once the transfer tray 300 is unloaded from the robot, it can be returned to the open position by disengaging latch 212 from latch receiver 214 and opening top portion 210. Vessel holder 100 can then be removed from stand 200.

At this point, it is possible to transfer more than one, and in most cases all, of the one or more vessels 1000 into together another holder for further manipulation or analysis without the need to remove any of the one or more vessels 1000 from vessel holder 100.

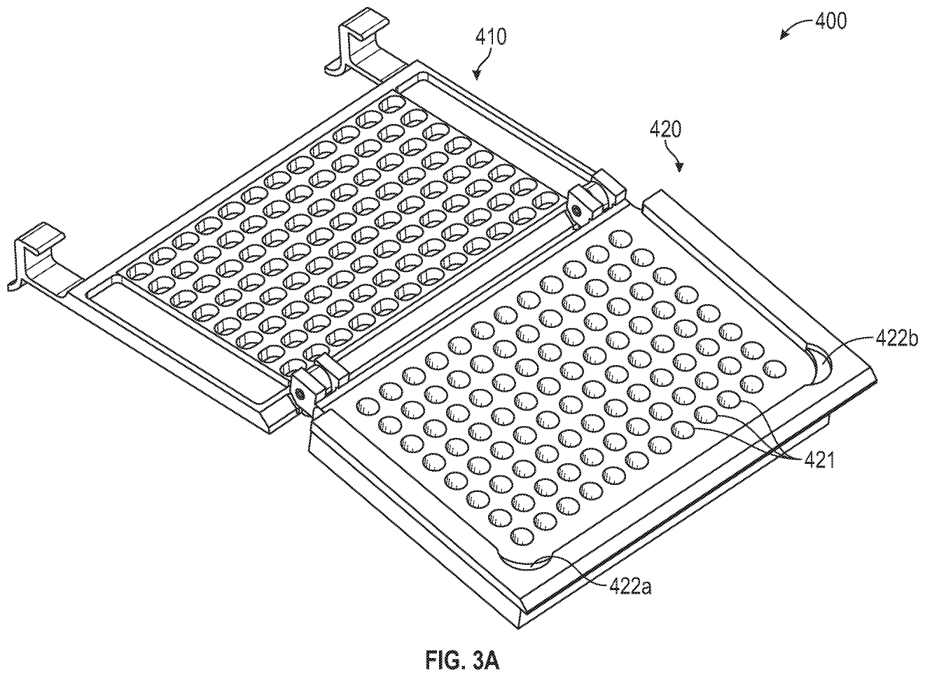

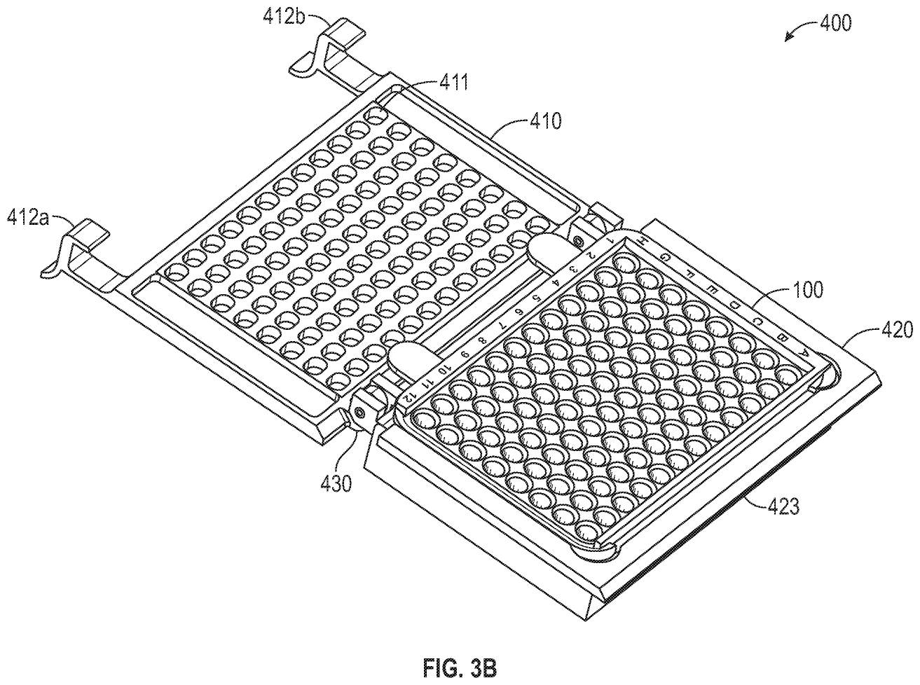

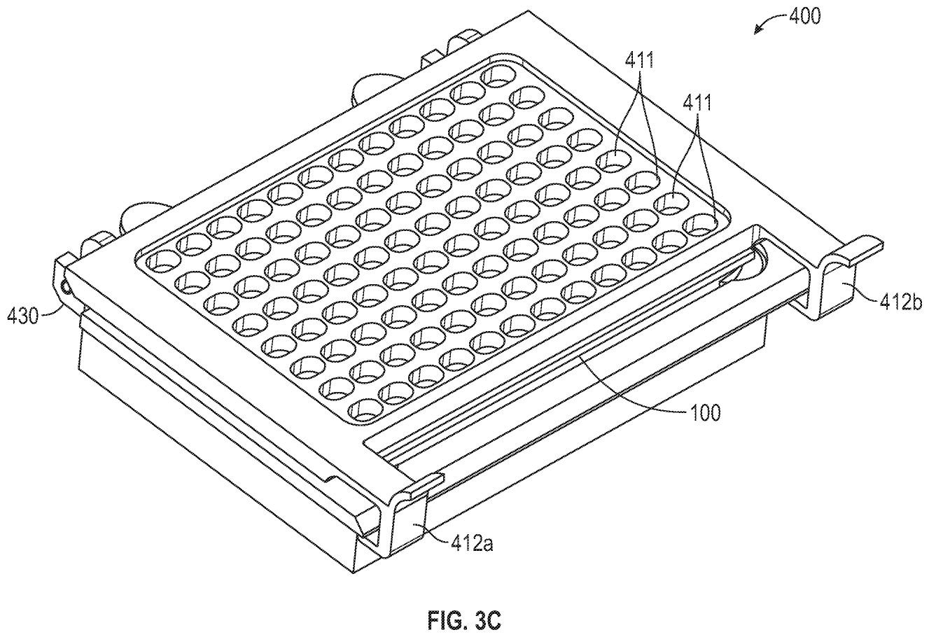

This can be illustrated by turning to FIG. 3A which depicts block 400, having a top portion 410 and bottom portion 420, the latter containing a plurality of holes 421 as well as a plurality of recesses 422a and 422b. Recesses 422a, 422b are sized to receive one or more of tabs 120a, 120b, 120e, and 120d of vessel holder 100, and the plurality of holes 421 are sized to receive one or more vessels 1000. As such, vessel holder 100, along with all of the one or more vessels 1000 loaded therein can be removed from stand 200 and placed all at once in block 400.

FIG. 3B shows vessel holder 100 deployed in block 400. In this Figure, vessels 1000 are not shown for clarity, but it should be understood that one or more of vessels 1000 can be loaded into block 400 along with vessel holder 100. Top portion 410 of block 400 can then be closed by way of hinge 430 and secured in place by hooking hooks 412a, 412b, over lip 423 in bottom portion 420.

A closed configuration of block 400 is depicted in FIG. 3C, where openings 411 are aligned with openings 1110 in vessel holder 100 to allow access of the interior of vessels 1000 (omitted from this figure for clarity).

Block 400 can be sized and shaped for loading into another device or robot for further manipulation. For example, if the content of one or more vessels 1000 includes DNA for amplification, then block 400 may be placed in a heating block or chamber for appropriate heating. Block 400 may also be sized and configured to placed in an appropriate instrument or detector for analysis of the contents of one or more of the vessels 1000.

While it is possible to remove the remnants of pipette tip-pierceable film 2000 at any point after addition or removal of liquid from the one or more vessels 1000, this may not be required because block 400 can be sized to accommodate the remnants of pipette tip-pierceable film 2000 that remain on vessel holder 100. Further, once a pipette tip pierces pipette tip-pierceable film 2000, it is possible to access the content of the one or more vessels 1000 without removing the pipette tip-pierceable film 2000.

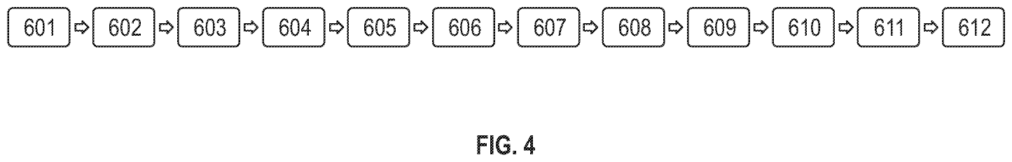

An method flow chart is depicted in FIG. 4. The method can include first step 601 of providing a transfer tray as described, herein, This step is optional, and is employed when a transfer tray is used. Once provided, second step 602 can include loading one or more vessels into holes of the vessel holder of the transfer tray and third step 603 can entail loading the vessel holder into the stand of the transfer tray such that at least one of the plurality of asymmetric tabs are received in at least one of the plurality of recesses. Optionally, third step 603, which is a loading step, can also include loading one or more capped vessels into the holes of the vessel holder of the transfer tray. The second and third steps can be omitted when a transfer tray is not used.

When the vessels are capped, fourth step 604 can be decapping the vessels. This fourth step 604 is not needed when the vessels are not capped, and so it may be omitted in some cases.

The vessels, which at this point are typically not capped or otherwise covered, are then covered with a pipette tip pierceable film in fifth step 605 and loaded onto a deck of a robot in sixth step 606. The order of the fifth and sixth steps can be reversed in some cases. The robot uses a pipette tip to pierce the pipette tip-pierceable film in seventh step 607, and subsequently either dispenses liquid into or removes liquid from the one or more vessels in eighth step 608.

In ninth step 609, which is optional, the robot can remove liquid from one or more vessels and then return the liquid back into the vessel from which it was removed, thereby mixing the contents of the vessel.

In tenth step 610, which is optional, the one or more vessels, along with the transfer tray when it is employed, can be removed from the robot and optionally the vessel holder can be removed from the transfer tray, in which case the vessel holder along with all of the vessels loaded in the vessel holder can be transferred together for further manipulation or analysis without removing the vessels from the vessel holder.

In eleventh step 611, the transfer tray is removed from the robot and the vessel holder is removed from the transfer tray. The vessel holder, along with at least some, but in most cases all, of the vessels loaded in the vessel holder are then transferred to another location (i.e., out of the stand) for further manipulation or analysis.

In twelfth step 612, the vessel holder is transferred into a block, such as the block described herein. When the block is a block of FIG. 3, then the top portion of the block can optionally be closed to retain the vessel holder on or in the block.

It should be noted that the block diagram of FIG. 4 and method described with reference to that Figure are illustrative, and that in some cases the steps can be performed in a different order from the order that was illustrated.

1. A transfer tray comprising
a vessel holder, the vessel holder comprising
a plurality of openings sized to contain one or more vessels such that when one or more vessels are contained in the vessel holder a first portion of each of the one or more vessels is situated above the vessel holder and a second portion of each of the one or more vessels that is contained is situated below the one or more openings, and
a plurality of asymmetric tabs; and
a stand, the stand comprising
a top portion and a bottom portion,
wherein the bottom portion comprises
a void for receiving at least a portion of the vessel holder,
a plurality of recesses for receiving the plurality of asymmetric tabs, the plurality of recess oriented such that the there is only one orientation of the vessel holder in which the plurality of asymmetric tabs can be received by the plurality of recesses, and
one or more legs extending from the bottom portion, the one or more legs being sized and oriented so that when one or more vessels are retained in the vessel holder and the vessel holder is received in the void the one or more legs extend below the one or more openings; and
wherein the top portion comprises one or more holes and is moveable between an open and a closed position such that when the top portion is in a closed position and the vessel holder is received in the void
the top portion retains the vessel holder, and
the holes in the top portion align with the openings in the vessel holder.

2. The transfer tray of claim 1, wherein the openings of the vessel holder comprise a bevel.

3. The transfer tray of claim 1, wherein when the vessel holder contains one or more vessels and is received in the stand, the legs of the stand extend beyond the portion of the vessels that are situated below the one or more openings in the vessel holder.

4. The transfer tray of claim 1, wherein the top portion of the stand and the bottom portion of the stand are connected by a hinge.

5. The transfer tray of claim 1, wherein the top portion of the stand comprises a latch and the bottom portion of the stand comprises a latch receiver, and wherein the latch and the latch receiver are oriented to engage when the stand is in a closed position.

6. The transfer tray of claim 1, wherein the vessel holder comprises 96 openings and wherein the top portion of the stand comprises 96 holes.

7. The transfer tray of claim 1, wherein the holes in the vessel holder are sized to contain one or more Eppendorf tubes, one or more PCR tubes, or one or more test tubes.

8. The transfer tray of claim 1, wherein the vessel holder contains one or more uncapped vessels and wherein the one or more uncapped vessels are covered by a pipette tip-pierceable film.

9. A method of transferring liquid, the method comprising
covering one or more vessels with a pipette tip-pierceable film;
loading the one or more vessels onto a deck of a robot, the robot being able to be equipped with a pipette tip to dispense or take up liquid;
equipping the robot with the pipette tip;
piercing, by the pipette tip, the pipette tip pierceable film; and
dispensing liquid into at least one of the one or more vessels or removing liquid from one or more of the at least one or more vessels.

10. The method of claim 9, comprising dispensing liquid into at least one of the one or more vessels.

11. The method of claim 9, comprising removing liquid from one or more of at least one or more vessels.

12. The method of claim 11, comprising ejecting the liquid removed from one or more of the at least one or more vessels back into the vessel from which the liquid was removed to mix the contents of the vessel.

13. The method of claim 9, wherein the step of equipping the robot with the pipette tip occurs before the step of loading the one or more vessels onto a deck of a robot.

14. The method of claim 9, wherein the step of equipping the robot with the pipette tip occurs after the step of loading the one or more vessels onto a deck of a robot.

15. The method of claim 9, further comprising, before the step of loading the one or more vessels onto a deck of a robot, a step of loading one or more of the vessels into a transfer tray according to any of claims 1-8.

16. The method of claim 9, further comprising a step of decapping the one or more vessels prior to covering the one or more vessels with the pipette tip-pierceable film.

17. The method of claim 15, further comprising
removing the transfer tray from the robot;
removing the vessel holder from the transfer tray; and
transferring the vessel holder along with the vessels loaded in the vessel holder to another location for further manipulation or analysis.

18. The method of claim 9, further comprising, after the step of dispensing liquid into at least one of the one or more vessels or removing liquid from one or more of the at least one or more vessels, a step of subjecting the vessels to a DNA amplification protocol.

19. The method of claim 18, wherein the DNA amplification protocol is PCR or LAMP.

20. The method of claim 9, wherein the step of dispensing liquid into at least one of the one or more vessels or removing liquid from one or more of the at least one or more vessels comprises dispensing liquid into at least one of the one or more vessels.

21. (canceled)
